(19) United States
(12) Patent Application Publication
(10) Pub. No.: US 2004/0252290 A1
(43) Pub. Date: Dec. 16, 2004

(54) Optical strain gauge and methods of use including a wind measurement device

(76) Inventors: Gary W. Ferguson, Burnaby (CA); Gerald Philip Gillis, Fort Nelson (CA); Branko Palcic, Vancouver (CA)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/458,464

(22) Filed: Jun. 10, 2003

(51) Int. Cl. G01B 11/16

(52) U.S. Cl. 356/32

(57) ABSTRACT

The present invention is a device to measure wind velocity and/or direction. These measurements may be useful for various outdoor activities including hunting, golfing, sailing, fishing, photography, kite-flying, parachuting, fireworks displays or other activities that are influenced by wind conditions. In broader context, sensitive detection of pressure (force) is important in everything from aeronautics to the design of biological sensors. In general, the majority of existing devices to measure wind depend on wind's interaction with a relatively large mass, thus limiting sensitivity. Although various types of sensors including optical strain gauges with the desired sensitivity exist, they are too large, complex or expensive to be broadly exploited. The present invention provides a relatively simple, inexpensive and sensitive pressure sensor (optical strain gauge) for incorporation in a wind-measuring device. In some embodiments wind speed is determined and wind direction is provided in relative terms, for example, towards the user or away from a fixed point. In other embodiments a compass may be integrated into the device or a reference direction may be input into the device to provide absolute directional indication. In other embodiments the device may be relatively small and portable.

### BACKGROUND

Wind is commonly defined as the flow of air relative to the earth's surface. Accordingly, wind may be described in terms of direction and velocity. Wind direction is typically measured with devices such as weather vanes and wind velocity is typically measured by means of anemometers or radar. Anemometers may be formed from cups or other rotating elements typically attached to an electrical device that translates rotation into an electrical signal representative of the wind's velocity. A pitot tube may also be used to measure wind velocity whereby a pressure differential is created as the wind blows across the tube, providing a mathematical basis to calculate wind speed. Radar-like devices used to measure wind velocity typically exploit Doppler effects produced by directing microwaves or other forms of energy at particles such as rain or dust in the air.

Circa 1805, Admiral Sir Francis Beaufort of the British navy attempted to standardize the nomenclature of winds of different velocities establishing the Beaufort scale. An adaptation of Beaufort's scale is currently used by the U.S. National Weather Service, employing a scale ranging from 0 for calm to 12 for hurricane, each velocity range being identified by its effects on such things as trees, signs, and houses. Winds may also be classified according to their origin and movement, such as heliotropic winds, which include land and sea breezes, and cyclonic winds. While existing devices meet general needs, there is a pent-up need for a device that can assess wind for various outdoor activities including hunting, golfing, sailing, fishing, photography, kite-flying, parachuting, fireworks displays or other activities that are influenced by wind conditions. In some instances wind measurement devices may be stationary and the information may be transmitted to the interested party. In other instances a portable device or an array of sensors may be utilized.

A transducer is a device that is typically used to convert one property, such as displacement, into an output quantity, such as a change in voltage, which may also be digitized. Electrical circuits with signal conditioning are often used to measure changes in electrical impedance, exploiting various properties such as stretching a resistor or piezo-electric crystal, moving an electrical coil, altering the distance between dielectrics (capacitance), altering vibration frequency, or changing the illumination to a photo-detector such as a photocell, phototransistor, linear array or CCD.

A device to measure force is typically comprised of a transducer and supporting instrumentation whereby force acting on the transducer causes a change in voltage, current, or frequency etc. which is measured by the supporting instrumentation. The instrumentation may power the transducer or further process the transducer output (e.g. amplification, triggering comparators, analog to digital conversion etc.) before these changes in force are indicated to the user. Accordingly, a transducer is a device that receives a physical stimulus such as and converts it into another measurable physical quantity via an established relationship. For example, a compressing force acting upon a metal rod may change its size or shape and thus alter the electrical resistance of an attached strain gauge (a transducer) bonded to the surface of the rod, and the supporting instrumentation would measures this change in resistance. Such instrumentation may be a simple dial gauge or the change may be computer processed and digitized for display. The indicated value may be in units of force, voltage or another parameter for which a relationship has been established. Values may be calculated and may further include calibration to correct or minimize system variables such as temperature, humidity, etc. A strain gauge is a form of pressure transducer and the wind detector discussed herein provide supporting instrumentation.

Strain gauges have been designed and utilized for a broad range of applications and a number of relatively complex and/or expensive devices employ optical strain gauges which incorporate Bragg-gratings or other elements. In some embodiments the present invention further seeks to provide a sensitive sensor which is relatively simple and inexpensive. While this application focuses on measuring wind, in general the sensor portion of the device may be utilized where appropriate.

In general, the majority of existing devices require that wind interact with a relatively large mass, which may limit such devices' sensitivity and applicability. Although more sensitive detectors, such as optical strain gauges, exist, they are too large, complex or expensive to be broadly exploited. The present invention provides a relatively simple, inexpensive and sensitive pressure sensor (optical strain gauge) and exploits this sensor in a wind-measuring device.

U.S. Pat. No. 3,534,191 to Siakel entitled “Electrical wind velocity indicator and alarm” describes a pendulum device which may be attached to exposed areas of a building wall or roof. Movement is sensed and feedback provided with optical and visual indicators.

U.S. Pat. No. 3,964,038 to Rutherford entitled “Wind Indicator” discusses a cylinder that moves laterally and a flat contact surface. The device may be particularly useful in detecting and warning of severe weather conditions.

U.S. Pat. No. 4,488,431 to Miga entitled “Wind speed direction indicator and electric current generating means” discusses a wind indicator spherically rotatable about a liquid supported poly-axial magnetic compass. In some embodiments a responsive rudder and wings are utilized. Applications include mounting on a sailboat as a means to generate an electric current.

U.S. Pat. No. 4,548,074 to Krueter entitled “Wind speed and direction indicator” discusses an anemometer with actuators rotating between coils to detect wind induced motion.

U.S. Pat. No. 5,349,334 to Parson entitled “Wind velocity signaling apparatus” discusses another means of assessing wind using a counter force assembly and the translation/generation of an electrical response.

U.S. Pat. No. 3,896,375 to Trolliet entitled “System for monitoring and indicating peak values of a time varying signal” among other things discusses voltage comparator and indicator circuits. These principals may be exploited by the present invention.

U.S. Pat. No. 4,102,191 to Harris entitled “Digital fuel gauge” discusses circuits, digital conversion and indication. These principals may be exploited by the present invention.

U.S. Pat. No. 6,464,364 to Graves entitled “Deformable curvature mirror” discusses electro-restrictive materials and means of controlling the curvature of a mirror.

U.S. Pat. No. 5,719,846 to Matoba entitled “Deformable mirror and method for fabricating the same and apparatus using a deformable mirror” among other things discusses uses of a deformable mirror for focusing light onto an optical disk.

U.S. Pat. No. 4,911,016 to Miyazaki entitled “Semiconductor strain gauge bridge circuit” discusses strain gauge circuits and methods of temperature compensation.

U.S. Pat. No. 4,442,718 to Komarova entitled “Strain gauge and electric circuit for adjustment and calibration of same” discusses strain gauge circuits.

U.S. Pat. No. 3,654,545 to Demark entitled “Semiconductor strain gauge amplifier” among other things discusses the strain gauge circuits, including semiconductor amplifiers and temperature compensation. These principals may be exploited for the present invention.

U.S. Pat. No. 5,827,967 to Ueyanagi entitled “Semiconductor accelerometer including strain gauge forming a Wheatstone bridge and diffusion resistors” discusses a sensor element and support frame as well as application and design considerations for using strain gauges. These principals may be exploited for the present invention.

U.S. Pat. No. 4,809,536 to Nishiguchi entitled “Method of adjusting bridge circuit of semiconductor pressure sensor” discusses strain gauges, circuits and design considerations.

U.S. Pat. No. 6,417,507 to Malvern entitled “Modulating fibre Bragg grating strain gauge assembly for absolute gauging of strain” discusses means to determine an absolute direction and magnitude of strain based on a ration of intensity values.

U.S. Pat. No. 6,101,884 to Haake entitled “Fastener equipped with an untethered fiber-optic strain gauge and related method of using the same” discusses a fiber optic staring gauge embedded in the bore of a structure.

U.S. Pat. No. 4,777,358 to Nelson entitled “Optical differential strain gauge” among other things discusses use of polarized light in measuring strain.

U.S. Pat. No. 4,717,253 to Pratt entitled “Optical strain gauge” discusses laser light and the measurement of strain using optical fibers, for example, by assessing changes in strain induced optical transmission.

U.S. Pat. No. 5,132,529 to Weiss entitled “Fiber-optic strain gauge with attached ends and unattached microbend section” discusses means of assessing strain based on increases in optical transmission by reducing deformations.

U.S. Pat. No. 4,761,073 to Meltz entitled “Distributed spatially resolving optical fiber strain gauge” discusses spectral shifts as a means to comprising a fiber optic strain gauge.

U.S. Pat. No. 4,163,397 to Harmer entitled “Optical strain gauge” discusses measuring strain in a solid object including analyzing changes in light propagation.

In general, as will be discussed in association with the figures and various embodiments, strain gauges are typically attached to a structure. Typically the structure does not deform significantly, so that the strain gauge is not damaged, warped, or delaminated as a result. Existing optical strain gauges are relatively complex and rely on optical transmission, sometimes requiring a precision light source such as a laser. Reducing optical effects to a measurement by computing or otherwise assessing optical transmission, spectral shifts, or birefringence patterns is relatively complex. Further, when a deformable mirror is utilized in an optical strain gauges, the mirror is typically a precision component and design goals often involve means to control the deformation of the mirror. The present invention is a simple, optical strain gauge which utilizes an elastic membrane, coated with a reflective film or coating as a deformable mirror. The mirror derives a general shape based on a support structure. In embodiments that utilize optical fibers, measurement results from physically shifting of the fiber. Accordingly, this provides a means of detecting the amount of deformation of the membrane, which for use in a wind-measuring device is a function of wind speed and/or direction.

### SUMMARY

The present invention comprises a source of radiation that emits light either directly to a mirrored, deformable membrane, or through optic fibers that are attached to the deformable membrane. The light is reflected by the mirrored membrane to a sensor, or is transmitted by the fiber optics to a sensor. The membrane deforms in response to strain applied by an outside source. As the membrane deforms, the amount of light incident on the sensor changes, providing a measure of the amount of strain applied to the membrane.

### BRIEF DESCRIPTION OF THE DRAWINGS

The organization and manner of the structure and operation of the invention, together with further objects and advantages thereof, may best be understood by reference to the following description, taken in connection with the accompanying drawings:

FIG. 1 shows the principles of a simple optical strain gauge.

FIG. 2 shows another means of forming a simple optical strain gauge.

FIG. 3 shows a wind-measuring device employing an optical strain gauge.

FIG. 4 shows another portable wind-measuring device with optical strain gauge.

### DESCRIPTION OF THE PREFERRED EMBODIMENTS OF THE INVENTION

While the invention may be susceptible to embodiments in different forms, there is shown in the drawings, and herein will be described in detail, a specific embodiment with the understanding that the present disclosure is to be considered an exemplification of the principles of the invention, and is not intended to limit the invention to that as illustrated and described herein.

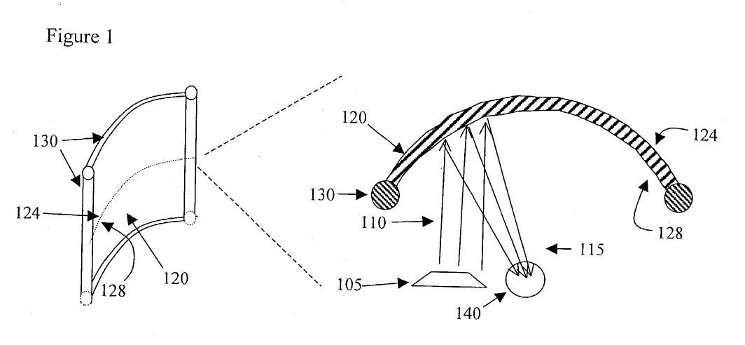

FIG. 1 shows a basic optical strain gauge to measure pressure exerted, for example, from wind on an optically responsive surface. Deformable membrane 120 has exterior surface 124 with interior reflective surface 128. The deformable membrane is supported and substantially derives its shape from support structure 130. Further shown in cross section, the deformable membrane 120 when combined with light source 105 and photo-detector 140 comprise an optical strain gauge with the reflective membrane functioning as a deformable mirror, however, unlike typical deformable mirrors, which typically include means to control their shape, this elastic membrane derives its shape substantially from its support structure 130. Light source 105 provides light rays 110, directed towards the reflective inner surface 128 of deformable membrane 120. Light 110 interacts with the reflective inner wall 128 reflecting light 115 onto photo-detector 140 which produces a voltage proportional to the amount of light 115 reaching the detector. The focal point of the mirror in this instance is approximately 1/2 the radius of curvature for the deformable mirror.

Light source 105 may be a lamp, an LED or be comprised of multiple LEDs of the same or different wavelengths. Infrared light, for example, may help minimize effects external or stray light. A columnating lens may be incorporated in what comprises light source 105 to provide generally parallel light to the concave or otherwise shaped mirrored surface 128. Similarly, other optical elements such as lenses, slits, fixed mirrors, optical coatings etc. may be used to condition light directed at the reflective inner wall 128 or conditioning light to be directed and captured by the photo-detector 140 which could be a photocell, phototransistor, linear array or CCD, for example. The device as diagramed supports capture of a portion of what would be a vertical band of light. Light may be directed from a desired position from more than one source as required or desired. Similarly, a spherical lens may be position in front of the photodetector to capture more light, or as diagramed, a linear array of photodetectors may be positioned to capture more of the vertical band of reflected light. Some of these factors may be optimized for a particular application and desired operating range. In the case of a wind detector, low cost, simplicity and portability provide design considerations. As discussed in association with the prior art, strain gauges are often established in a bridge configuration with matched resistive elements for temperature compensation. Accordingly, a second, un-illuminated photodetector could be employed in a balancing arm of a bridge circuit.

In operation, the device may function as a wind detector, for example. Membrane 120 may be sheltered to establish an initial calibration measurement (reference zero input) to minimize the effects of temperature, humidity or slight changes in the deformability of membrane 120 which may be due to aging, or changes in the light source or photo-detector, for example. Then a second reading or series of reading (integration) are taken when pressure, such as contact or wind, interacts with membrane 120, causing it to deform. Deformation of the membrane changes the amount of light 115 reaching the photo-detector and thus produces a change in voltage, or signal which is proportional to the amount of membrane deformation, or force. As represented, the amount of light 115 reaching the photo-detector 140 as diagramed is at a maximum when no force is applied to the membrane 120. Accordingly, this provides a relatively simple and inexpensive optical stain gauge. A low mass, elastic membrane is generally desirable for high sensitivity, although these properties may be adapted to optimize the optical strain gauge for a particular application or to measure forces in a desired range. For portability, batteries, or a rechargeable battery that may be charged externally or via an integrated solar cell, may be preferred.

While the general shape of the deformable mirror diagramed is concave in, various optical changes could be incorporated to utilize a flat, convex, corrugated or other shape of deformable mirror within the spirit of this invention. Practical methods of displaying voltages from the optical strain gauge and more particularly for a wind-measuring device will be further discussed.

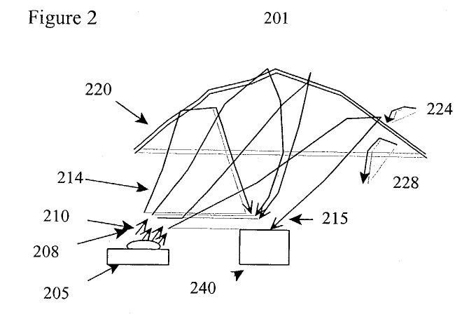

FIG. 2 shows another configuration of optical strain gauge 201, again comprised of three main components: light source, deformable membrane and photo-detector. Illumination is provided by light source 205 which in this instance is focused by optical element 208 (e.g., a lens), directing light 210 into optical fibers 214. Deformable membrane 220 has outer surface 224 and inner surface 228, which is in contact with one or more optical fiber(s) 214. In this instance, a linear array 240 is utilized as a photo-detector responding to changes in the amount and position of light 215 arriving via the optical fibers and contacting its array of sensors.

While the general shape of the deformable membrane diagramed is concave, a flat, convex, corrugated or other shape of deformable surface may be utilized within the spirit of this invention. Light source 205 may be a lamp, a single LED or multiple LEDs of the same or various desired wavelengths. As will be further discussed, other optical elements may be used to further shape or otherwise optimize the signal produced. Similarly, photo-detector 240 may be replaced by a CCD or other form of optical sensor supporting sensing deformation of the membrane or imaging that deformation in two dimensions when an array of fibers is used.

In operation, the membrane 220 may be sheltered to establish an initial calibration measurement to minimize the effects of temperature, humidity or slight changes in the deformability of membrane 220 which may be due to aging, or changes in the light source or photo-detector, for example. Then a second reading or series of reading are taken when pressure, such as contact or wind blowing, causes membrane 220 to deform. Deformation of membrane 220 changes the amount of light 215 that reaches the photo-detector 240 and thus produces a change in voltage, which is proportional to the amount of membrane deformation, or force. This provides a relatively simple and inexpensive optical stain gauge. A low mass, elastic membrane is generally desirable for high sensitivity, although these properties may be adapted to optimize the optical strain gauge for a particular application or to measure forces in a desired range. Similarly, in this instance fibers of the same or different flexibility may be use to optimize a sensor for a particular application. To maintain intimate contact with the membrane 220, fibers may be cemented, embedded in the membrane or otherwise have their contact fixed in relation to the deformable membrane 220. Again, unlike other optical strain gauges which generally sense a change related in optical properties, such as transmission, the present device derives its functionality by allowing a physical shift in the fibers' position.

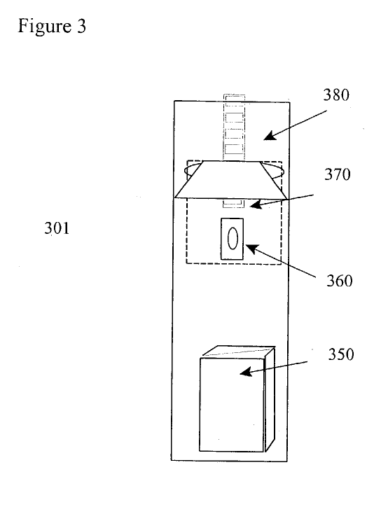

FIG. 3 shows a hand held wind detector 301 comprised of power supply 350, in this instance a 9V battery, thumb activation switch 360, graphical readout indicator 370, which in this instance is a VU meter using a series of LED indicators which translates voltage to wind speed indication, and optical strain gauge 380 as discussed in association with FIGS. 1 and 2.

As required or desired, numbers may be inscribed beside the respective LED indicators or A/D conversion may be provided and LED gauge 370 could be a numeric gauge, such as a liquid crystal display or comparable indicator providing a numeric readout.

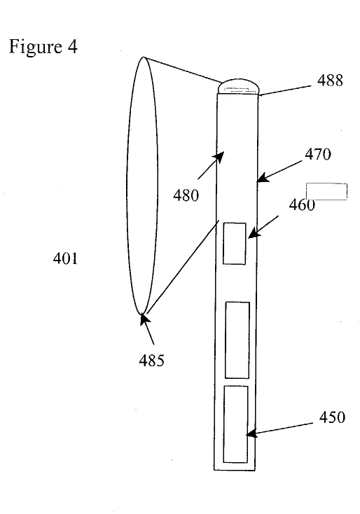

FIG. 4 shows another configuration of hand held wind detector 401 comprised of battery supply 450, thumb activation switch 460, wind speed indicator 470 and optical strain gauge 480 as discussed in association with FIGS. 1 and 2. Also diagramed is wind-scoop 485 providing increased sensitivity and range switch 488 which is activated in this instance by the attachment of wind-scoop 485. As required or desired, a numeric liquid crystal display or other appropriate indicator may be used as a read out device to indicate wind speed.

While for many applications a relative indication of wind direction, such as towards the user or away from a fixed point may be sufficient, a compass may be easily incorporated into the device to provide absolute directional indication. Alternatively, as cost, complexity and other issues dictate, an array of sensors, for example set up in an octagon with eight dedicated sensors, so deposed, such as one for N, one for SW etc. could be assembled on these principles.

Other features of interest could include data transmission, so that for example a distributed array of devices could be used to collect information and this information could then be transmitted to a central data processing station for use or retransmission. This may have value in industrial situations or for wind detection an array of devices could be distributed around a golf course to collect data for redistribution to golf carts or individual golfers equipped with a wrist-worn readout, for example.

Please note that many variations can be made of this apparatus without departing from the invention. While a preferred embodiment of the present invention is shown and described, it is envisioned that those skilled in the art may devise various modifications of the present invention without departing from the spirit and scope of the appended claims.

We claim:

1. An optical strain gauge to measure force, comprising
a source of radiation,
a membrane deformable in response to an externally-applied force,
a reflective surface on said membrane, receiving said radiation and reflecting said radiation to a sensor,
whereby an amount of reflected radiation received by said sensor changes as said membrane deforms.

2. The apparatus of claim 1, whereby said source is at least one light-emitting diode.

3. The apparatus of claim 1, further comprising means to condition said radiation.

4. The apparatus of claim 1, whereby said apparatus is portable.

5. The apparatus of claim 1, whereby said sensor is a photocell, a phototransistor, or a CCD.

6. The apparatus of claim 1, further comprising means to display said amount of said reflected radiation received by said sensor.

7. The apparatus of claim 6, wherein said means to display said amount is digital.

8. The apparatus of claim 6, further comprising means to convert said amount of said reflected radiation received by said sensor to windspeed.

9. The apparatus of claim 8, further comprising means to display said windspeed.

10. The apparatus of claim 9, wherein said means to display said windspeed is digital.

11. The apparatus of claim 1, further comprising means to transmit said amount to a receiver.

12. The apparatus of claim 1, further comprising a compass.

13. An optical strain gauge, comprising
a source of radiation,
a membrane deformable in response to an externally-applied force
at least one optical fiber transmitting said radiation from said source to a sensor, said at least one optical fiber being in contact with said membrane and deformable as said membrane deforms,
whereby an amount of radiation transmitted to said sensor changes as said at least one optical fiber deforms.

14. The apparatus of claim 13, whereby said source is at least one light-emitting diode.

15. The apparatus of claim 13, further comprising means to condition said radiation.

16. The apparatus of claim 13, whereby said apparatus is portable.

17. The apparatus of claim 13, whereby said sensor is a photocell, a phototransistor, or a CCD.

18. The apparatus of claim 13, further comprising means to display said amount of said reflected radiation received by said sensor.

19. The apparatus of claim 18, wherein said means to display said amount is digital.

20. The apparatus of claim 18, further comprising means to convert said amount of said reflected radiation received by said sensor to windspeed.

21. The apparatus of claim 20, further comprising means to display said windspeed.

22. The apparatus of claim 21, wherein said means to display said windspeed is digital.

23. The apparatus of claim 13, further comprising means to transmit said amount to a receiver.

24. The apparatus of claim 13, further comprising a compass.

25. A wind-measuring device, comprising
a source of radiation,
a membrane deformable in response to wind,
a reflective surface on said membrane, receiving said radiation and reflecting said radiation to a sensor,
whereby an amount of said reflected radiation received by said sensor changes as said membrane deforms.

26. The apparatus of claim 25, whereby said source is at least one light-emitting diode.

27. The apparatus of claim 25, further comprising means to condition said radiation.

28. The apparatus of claim 25, whereby said apparatus is portable.

29. The apparatus of claim 25, whereby said sensor is a photocell, a phototransistor, or a CCD.

30. The apparatus of claim 25, further comprising means to display said amount of said reflected radiation received by said sensor.

31. The apparatus of claim 30, wherein said means to display said amount is digital.

32. The apparatus of claim 30, further comprising means to convert said amount of said reflected radiation received by said sensor to windspeed.

33. The apparatus of claim 32, further comprising means to display said windspeed.

34. The apparatus of claim 33, wherein said means to display said windspeed is digital.

35. The apparatus of claim 25, further comprising means to transmit said amount to a receiver.

36. The apparatus of claim 25, further comprising a compass.

37. A wind-measuring device, comprising
a source of radiation,
a membrane deformable in response to wind,
at least one optical fiber transmitting said radiation from said source to a sensor, said at least one optical fiber being in contact with said membrane and deformable as said membrane deforms,
whereby an amount of radiation transmitted to said sensor changes as said at least one optical fiber deforms.

38. The apparatus of claim 37, whereby said source is at least one light-emitting diode.

39. The apparatus of claim 37, further comprising means to condition said radiation.

40. The apparatus of claim 37, whereby said apparatus is portable.

41. The apparatus of claim 37, whereby said sensor is a photocell, a phototransistor, or a CCD.

42. The apparatus of claim 37, further comprising means to display said amount of said reflected radiation received by said sensor.

43. The apparatus of claim 42, wherein said means to display said amount is digital.

44. The apparatus of claim 42, further comprising means to convert said amount of said reflected radiation received by said sensor to windspeed.

45. The apparatus of claim 44, further comprising means to display said windspeed.

46. The apparatus of claim 45, wherein said means to display said windspeed is digital.

47. The apparatus of claim 37, further comprising means to transmit said amount to a receiver.

48. The apparatus of claim 37, further comprising a compass.
